(19) United States
(12) Patent Application Publication
(10) Pub. No.: US 2024/0150598 A1
(43) Pub. Date: May 9, 2024

(54) SOLUBLE GRAPHITE INK COMPOSITION

(71) Applicant: Angela Harris, San Diego, CA (US)

(72) Inventor: Angela Harris, San Diego, CA (US)

(21) Appl. No.: 17/981,423

(22) Filed: Nov. 6, 2022

(51) Int. Cl. C09D 11/17; B43K 19/02

(52) U.S. Cl. CPC C09D 11/17; B43K 19/02

(57) ABSTRACT

An erasable soluble graphite ink composition that may be adapted to an existing dauber applicator, resembling a writing instrument such as a pen or pencil. When applied by the dauber to a writing surface, provides for a machine-readable pattern. The dauber, when filled and utilized with the present composition and its alternate embodiments, allows for the rapid filling of apertures in one motion of the dauber, versus repetitive circling when using a conventional pencil. Such filling is viewed as saving between three to five times (3×-5×) the amount of time and is considered advantageous during usage in situations where time saving is a critical factor. Once applied to the writing surface, the composition may be erased using a standard pencil eraser, and remarked such that only the revised mark is read by the machine reader.

### TECHNICAL FIELD

The present invention relates to a liquid composition, and more particularly to a physically and chemically stable liquid composition including graphite material that may be used in computer read scanned cards and is also erasable using conventional pencil erasing methods.

### BACKGROUND

Computer readable cards are used in a wide variety of educational, industrial, and institutional environments. Such cards provide a straight forward and easy to understand human interface, fast machine reading, and almost no chance of error during the machine reading. Said cards rely on the user filling in an aperture, with a specific writing instrument, typically a number two (#2) pencil, with other variants possible. Should the human user make a mistake or change their mind, erasing remains an option in changing the entry due to the graphite in the pencil lead being easily removed by a standard eraser. However, one drawback associated with the use of such cards is that the user is often under time constraints to fill in the aperture, either during a testing session, or as part of one's job. The time required to fill in an aperture with multiple passes of a pencil may be significant and disadvantageous in certain scenarios. Such scenarios include but are not limited to a scantron test, a voting ballot card, a bingo card, attendance cards, lottery cards, SAT testing, K-12 standardized testing, and the like. As such, there remains a need to reduce the amount of time required to mark, erase, and possibly re-mark apertures on machine readable cards.

### SUMMARY

In view of the above, the present invention provides an erasable soluble graphite ink composition for use in a dauber applicator for the purposes of use in a computer readable card.

However, objects of the present invention are not restricted to the one (1) set forth herein. The above and other objects of the present invention will become more apparent to one of ordinary skill in the art to which the present invention pertains by referencing the detailed description of the present invention given below.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an exemplary view of a writing device with a solution.

FIG. 2 is an exemplary view of the ingredients of the solution shown in FIG. 1.

### DETAILED DESCRIPTION

### Base Composition Formulation

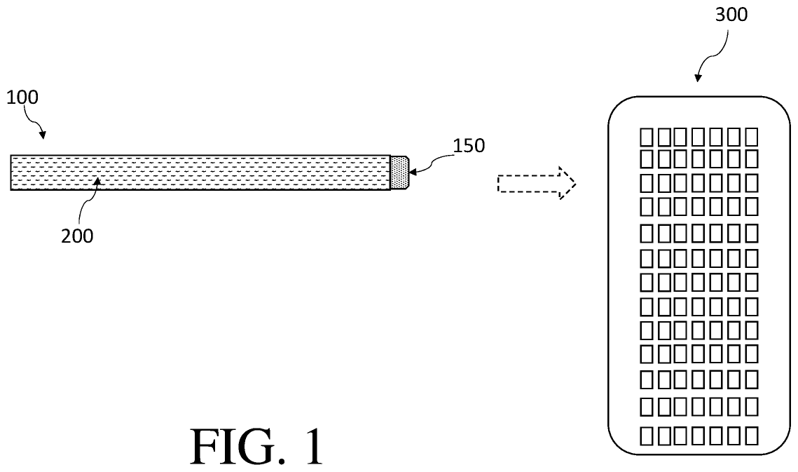

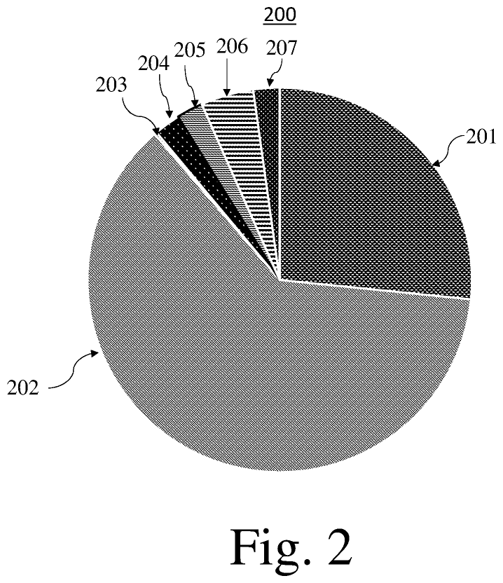

Referring to FIG. 1 and FIG. 2, the present invention, liquid in nature, provides an erasable soluble graphite ink composition 200 that may be adapted to an existing dauber applicator 150, resembling a writing instrument 100 such as a pen or pencil. The invention, when applied by the dauber applicator 150 to a writing surface 300 provides for a machine-readable pattern. The dauber applicator 150, when filled and utilized with the present composition 200 and its alternate embodiments, allows for the rapid filling of apertures in one motion of the dauber applicator 150, versus repetitive circling when using a conventional pencil. Such filling is viewed as saving between three to five times (3×-5×) the amount of time and is considered advantageous during usage in situations where time saving is a critical factor. Once applied to the writing surface 300, the composition 200 may be erased using a standard pencil eraser 160, and remarked such that only the revised mark is read by the machine reader. Table 1 below provides the target quantities of the composition.

TABLE 1
BASE COMPOSITION

| | | PERCENT |
|---|---|---|
| CHEMICAL | Wt. (grams) | COMPOSTION |
| Water (H₂O) 201 | 3.000 | 26.61% |
| Ethanol (C₂H₆O) | 7.000 | 62.09% |
| 202 | | |
| Triton X-100 203 | 0.024 | 0.21% |
| Glycerin (C₃H₈O₃) | 0.250 | 2.22% |
| 204 | | |
| Titanium Dioxide | 0.250 | 2.22% |
| (TiO₂) 205 | | |
| Sodium Alginate | 0.500 | 4.43% |
| (C₆H₈O₆)ₙ 206 | | |
| Graphite Powder (C) | 0.250 | 2.22% |
| 207 | | |
| TOTAL | 11.274 | 100.00% |

The base composition was created in a mix of ethanol 202 and water 201. First, seven grams (7 g; 62.09% wt.) of ethanol 202 was added to a vial (not shown). The ethanol 202 must be added quickly but steadily and the vial capped immediately to prevent the evaporation of ethanol vapors. Next, three grams (3 g; 26.61% wt.) of purified or distilled water 201 was added dropwise to the vial. The vial is then shaken for ten seconds (10 s) to ensure full mixing of ethanol 202 and water 201. Next, twenty-five hundredths of a gram (0.25 g; 2.22% wt.) vegetable glycerin 204 is added to thicken the solution and act as a surfactant. The vial is again shaken so that the glycerin 204 mixes well with the solution. One (1) drop of Triton X-100 203 is added to the vial (0.24 g; 0.21%). This ingredient is a highly viscous material that effectively disperses carbon meaning it will improve the mixing of graphite 207 in the solution while making it easy to wipe away during erasure off of paper. Once the liquid components are thoroughly mixed, the sodium alginate 206 is added at five-tenths of a gram (0.5 g; 4.43% wt) to the concoction. This increases the thickness of the solution and acts as an emulsifier to improve mixing of ingredients. The vial must be thoroughly and vigorously mixed at this point to ensure full dissolution of powder in a homogenous solution. Next twenty-five hundredths of a gram (0.25 g; 2.22% wt.) of titanium dioxide 205 is added to the vial. Titanium dioxide 205 acts as an exfoliant and abrasive when it comes to removing the graphite from paper when erasing. The last ingredient is graphite 207 powder, added at twenty-five hundredths of a gram (0.25 g; 2.22% wt.) to the entire solution.

### Base Composition Observations

Observations are that the solution works well with marking and erasure when utilized with a dauber applicator 150 upon a common computer read card (not shown). At these concentrations, the darkness resembles that of a number 2.5 pencil. As such, it is slightly lighter than the commonly required number 2 pencil for the vast majority of computer read cards. A disadvantage to the base composition formulation is that it starts to separate out after five minutes (5 min) so it requires continuous shaking of the dauber applicator 150 during usage.

### Alternate Embodiments

### Base Composition Revisions

Ethanol 202, water 202, glycerin 204, and Triton X-100 203 were kept at the same ratios. Sodium alginate 206 was replaced by hydroxy methylcellulose (not shown), also known as Hypromellose guar. This substitution of sodium alginate 206 with Hypromellose improved the surfactant and thickening quality at a much lower concentration (from four-point forty-three percent (4.43%) sodium alginate 206 to zero-point twenty percent (0.20%) Hypromellose). Titanium dioxide 205 was also replaced since it tended to unnecessarily lighten the composition and add to the overall weight of the powder which would cause the early separation after five minutes (5 min). Instead, activated charcoal (not shown) was used, which absorbed some of the other materials in the mixture and added to the overall stability of the formula. The ratios between activated charcoal and graphite powder 207 also made it easier to control color gradients for the purpose of making #3, #2.5, and #2 pencil darkness.

### Pencil #3 Formulation

First seven grams (7 g; 66.38% wt.) of ethanol 202 was added to a vial. Next, three grams (3 g; 28.45% wt.) of purified or distilled water 201 was added dropwise to the vial. The vial is then shaken for ten seconds (10 s) to ensure full mixing of ethanol 202 and water 201. Next, twenty-five hundredths of a gram (0.25 g; 2.37% wt.) vegetable glycerin 204 is added. The vial is again shaken so that the glycerin 204 mixes well with the solution. One (1) drop of Triton X-100 203 is added to the vial. Once the liquid components are thoroughly mixed, Hypromellose (not shown) is added at twenty-two thousandths of a gram (0.022 g; 0.21% wt.) to the concoction. The vial must be thoroughly and vigorously mixed at this point to ensure full dissolution of powder in a homogenous solution. Next twenty-five hundredths of a gram (0.25 g; 2.37% wt.) of activated charcoal (not shown) is added to the vial. No graphite powder 207 is included in the ink #3 formulation.

### Pencil #2.5 Formulation

First seven grams (7 g; 64.84% wt.) of ethanol 202 was added to a vial. Next, three grams (3 g; 27.79% wt.) of purified or distilled water 201 was added dropwise to the vial. The vial is then shaken for ten seconds (10 s) to ensure full mixing of ethanol 202 and water 201. Next, twenty-five hundredths of a gram (0.25 g; 2.32% wt.) vegetable glycerin 204 is added. The vial is again shaken so that the glycerin mixes well with the solution. One (1) drop of Triton X-100 203 is added to the vial. Once the liquid components are thoroughly mixed, Hypromellose (not shown) is added at twenty-two thousandths of a gram (0.022 g; 0.20% wt.) to the concoction. The vial must be thoroughly and vigorously mixed at this point to ensure full dissolution of powder in a homogenous solution. Next twenty-five hundredths of a gram (0.25 g; 2.32% wt.) of activated charcoal (not shown) is added to the vial. The last ingredient is graphite powder 207, added at twenty-five hundredths of a gram (0.25 g; 2.22% wt.) to the entire solution.

### Pencil #2 Formulation

First seven grams (7 g; 64.24% wt.) of ethanol 202 was added to a vial. Next, three grams (3 g; 27.53% wt.) of purified or distilled water 201 was added dropwise to the vial. The vial is then shaken for ten seconds (10 s) to ensure full mixing of ethanol 202 and water 201. Next, twenty-five hundredths of a gram (0.25 g; 2.29% wt.) vegetable glycerin 204 is added. The vial is again shaken so that the glycerin 204 mixes well with the solution. One (1) drop of Triton X-100 203 is added to the vial. Once the liquid components are thoroughly mixed, Hypromellose (not shown) is added at twenty-two thousandths of a gram (0.022 g; 0.20% wt.) to the concoction. The vial must be thoroughly and vigorously mixed at this point to ensure full dissolution of powder in a homogenous solution. Next forty hundredths of a gram (0.040 g; 3.67% wt.) of activated charcoal (not shown) is added to the vial. The last ingredient is graphite powder 207, added at twenty hundredths of a gram (0.20 g; 1.84% wt.) to the entire solution.

### Observational Usage Analysis

Each separate ink formulation was tested against a dark marking of each separate ink. Since the rule of thumb for marking computer readable cards, “heavy and dark”, markings with a conventional pencil of various types (#2, #2.5 and #3) were made on a standard piece of notebook paper as well as a computer read card.

Such marks were then visually compared with corresponding marks made by a dauber applicator 150 using the aforementioned described alternate formulations. Significant visual similarity was noted on the notebook paper as well as the computer readable cards. Next, the computer readable cards were read by an appropriate card reader with a one-hundred-percent (100%) matching rate. Finally, the aperture markings using the alternate embodiments were erased and remade on other apertures on the card. These cards were then re-read by the card reader with a one-hundred-percent (100%) matching rate.

All three (3) alternate formulations passed all test for being usable with a computer read scanner, including erased marks and subsequent remarking.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A soluble graphite ink composition for use with a machine reading device, the composition comprising:
a writing device, the writing device having a dauber applicator and a body;
a solution, the solution being contained in the body of the writing device and dispensed through the dauber applicator, the solution consisting of:
Water (H₂O);
Ethanol (C₂H₆O); and
Triton X-100.

2. The composition according to claim 1, wherein the writing device is a pen.

3. The composition according to claim 1, wherein the writing device is a pencil.

4. The composition according to claim 1, wherein the Water has a weight of 3.0 grams.

5. The composition according to claim 1, wherein the Ethanol has a weight of 7.0 grams.

6. The composition according to claim 5, wherein the Triton X-100 has a weight of 0.024 grams.

7. The composition according to claim 5, wherein the solution further consisting of:
Glycerin (C₃H₈O₃).

8. The composition according to claim 7, wherein the Glycerin has a weight of 0.25 grams.

9. The composition according to claim 7, wherein the solution further consisting of:
Titanium Dioxide (TiO₂).

10. The composition according to claim 9, wherein the Titanium Dioxide has a weight of 0.25 grams.

11. The composition according to claim 9, wherein the solution further consisting of:
Sodium Alginate (C₆H₈O₆).

12. The composition according to claim 11, wherein the Sodium Alginate has a weight of 0.5 grams.

13. The composition according to claim 11, wherein the solution further consisting of:
Graphite Powder (C).

14. The composition according to claim 13, wherein the Graphite Powder has a weight of 0.2 grams when a darkness of the solution is consistent with a #2 pencil.

15. The composition according to claim 13, wherein the Graphite Powder has a weight of 0.2 grams when a darkness of the solution is consistent with a #2.5 pencil.

16. The composition according to claim 13, wherein the Graphite Powder has a weight of 0 grams when a darkness of the solution is consistent with a #3 pencil.

17. The composition according to claim 1, wherein the solution further consisting of:
Glycerin (C3H8O3).

18. The composition according to claim 1, wherein the Water is distilled water.

19. The composition according to claim 1, wherein the Water is purified water.

20. The composition according to claim 1, wherein the solution is configured to be erased using a standard pencil eraser.
